(19) United States
(12) Patent Application Publication
(10) Pub. No.: US 2006/0021532 A1
(43) Pub. Date: Feb. 2, 2006

(54) Sheering device for folded fascicles

(76) Inventor: Mario Pane, Trino Vercellese (IT)

Correspondence Address: SHELDON & MAK, INC, 225 SOUTH LAKE AVENUE, 9TH FLOOR, PASADENA, CA, 91101, US

(21) Appl. No.: 10/914,796

(22) Filed: Aug. 9, 2004

Related U.S. Application Data
(60) Provisional application No. 60/592,859, filed on Jul. 30, 2004.

(51) Int. Cl. B41F 13/54

(52) U.S. Cl. 101/228

(57) ABSTRACT

A sheering device (1) for routing folded fascicles (2) advancing on a path through a printing line onto one or more than one collecting device (20) comprising a comb-shaped sheerer (3) adapted to assume a raised position and a lowered position with respect to the advancement path of fascicles (2), two or more than two cams (5) connected to the comb-shaped sheerer (3) which raise and lower the comb-shaped sheerer (3), and one or more than one motor (7). The one or more than one motor (7) is adapted to automatically select one of the two or more than two cams (5) and drive the selected cam (5) according to the upstream advancement speed of a folding machine (9) which folds the printed material into fascicles (2). In a preferred embodiment, at least one of the two or more than two cams (5) is adapted to realize at least two operating ratios.

### CROSS-REFERENCE TO RELATED APPLICATIONS

The present Application claims the benefit of U.S. provisional patent application 60/592,859 titled “Sheering Device for Folded Fascicles,” filed Jul. 30, 2004, the contents of which are incorporated in this disclosure by reference in their entirety.

### BACKGROUND

The production of bound printed material on paper, such as newspapers, magazines and books, commonly involves the initial creation of partial sections of the finished work, known as “fascicles,” which are gathered and bound into the finished work on a printing line, such as a rotary printing line. In general, a printing line comprises a folding machine which folds the printed paper into fascicles. The folded fascicles are then routed by a sheering device onto collecting devices, commonly called “spiders.” Collecting devices comprise a plurality of wings that are spirally arranged on the surface of a cylinder. During production, the folded fascicles lodge between two wings of a collecting device as the fascicles are gathered together into the final configuration of the finished work. A printing line comprises one or more than one collecting device, though generally a printing line has between one and three collecting devices.

As part of the production process, the sheering device must route the fascicles into the proper collecting device in the proper order. In order to route the fascicles toward the proper collecting device, the sheering device generally comprises a comb-shaped sheerer that can assume either a raised position with respect to the advancement path of the fascicles, or can assume a lowered position with respect to the advancement path of the fascicles. When the comb-shaped sheerer is in the raised position, the first folded fascicle that reaches the sheering device passes below the comb-shaped sheerer and is routed toward the collecting device immediately downstream of the sheering device. When the comb-shaped sheerer is in the lowered position, the first folded fascicle that reaches the sheering device passes above the comb-shaped sheerer and is routed toward a second sheering device and, thus, to a collecting device associated with the second sheering device, or to a third or subsequent sheering device and, thus, to a collecting device associated with the third or subsequent collecting device. The comb-shaped sheerer is lowered by a small roller that cooperates with a cam to lower the comb-shaped sheerer, and the comb-shaped sheerer is raised by the cam itself without the small roller.

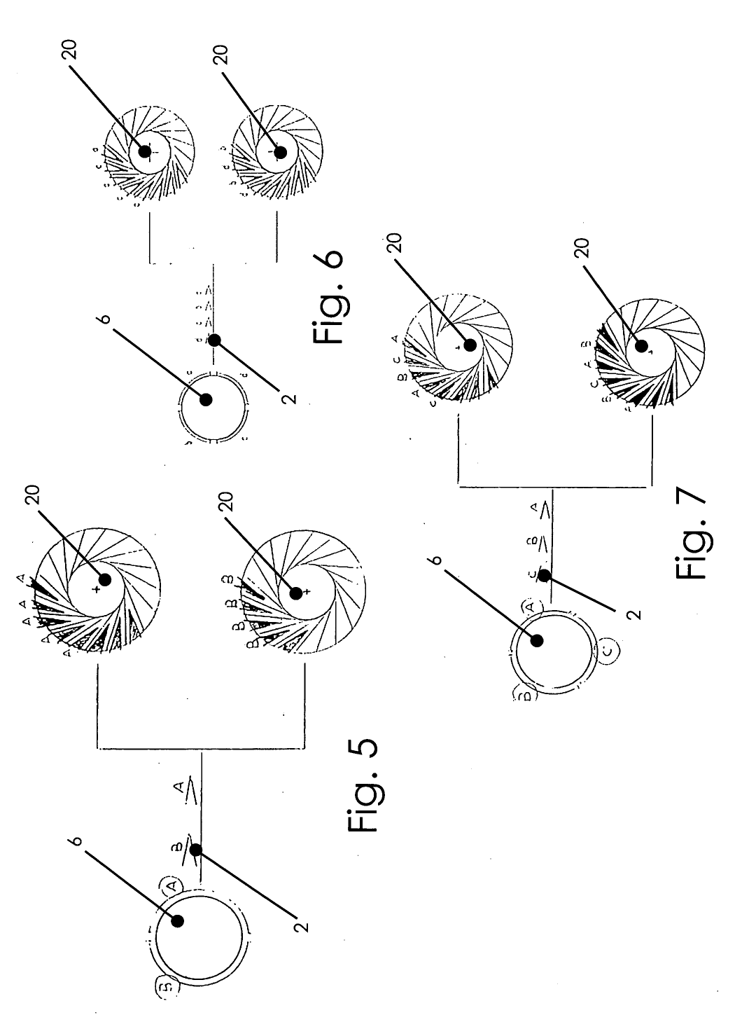

Referring now to FIG. 5 through FIG. 12, there are shown schematic depictions of various output combinations of different types of fascicles 2 being routed from a cylinder 6, which is part of the folding machine 9 upstream of a sheering device toward collecting devices 20. In order to obtain these combinations, the currently known sheering devices must be equipped with three different types of cams: a first type of cam that activates the sheering device enabling it to perform the sheering action every 180° of its rotation, a second type of cam that works every 120° of its rotation, and a third type of cam that works every 90° of its rotation by rotating at half of the speed of the first type of cam.

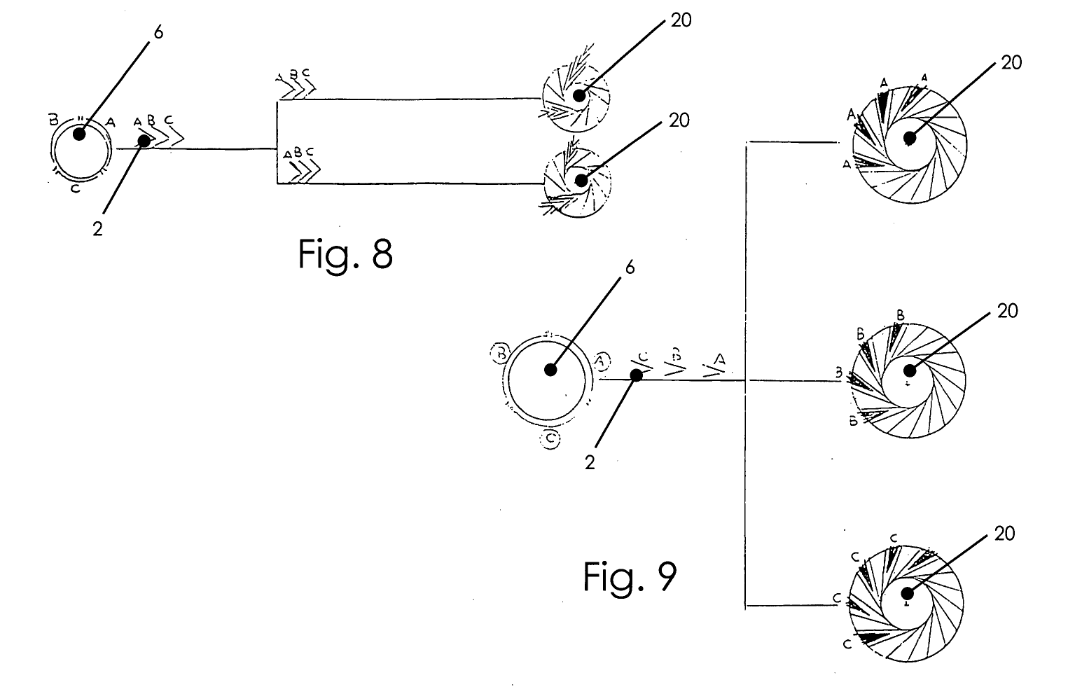

FIG. 5 through FIG. 8 show four potential outputs from the sheering device in which only the first type of cam is used. In FIG. 5, fascicles 2 of type A are routed toward a collecting device 20, while fascicles 2 of type B are routed toward another collecting device 20. In FIG. 6, fascicles 2 of types a and c are routed toward collecting devices 20, while fascicles 2 of types b and d are routed toward a different collecting device 20. In FIG. 7, fascicles 2 of types A, B and C are routed to two collecting devices 20 in the combination A, C and B. In FIG. 8, fascicles 2 of types A, B and C are routed one inside the other in the combination A, B and C on two separate collecting devices 20.

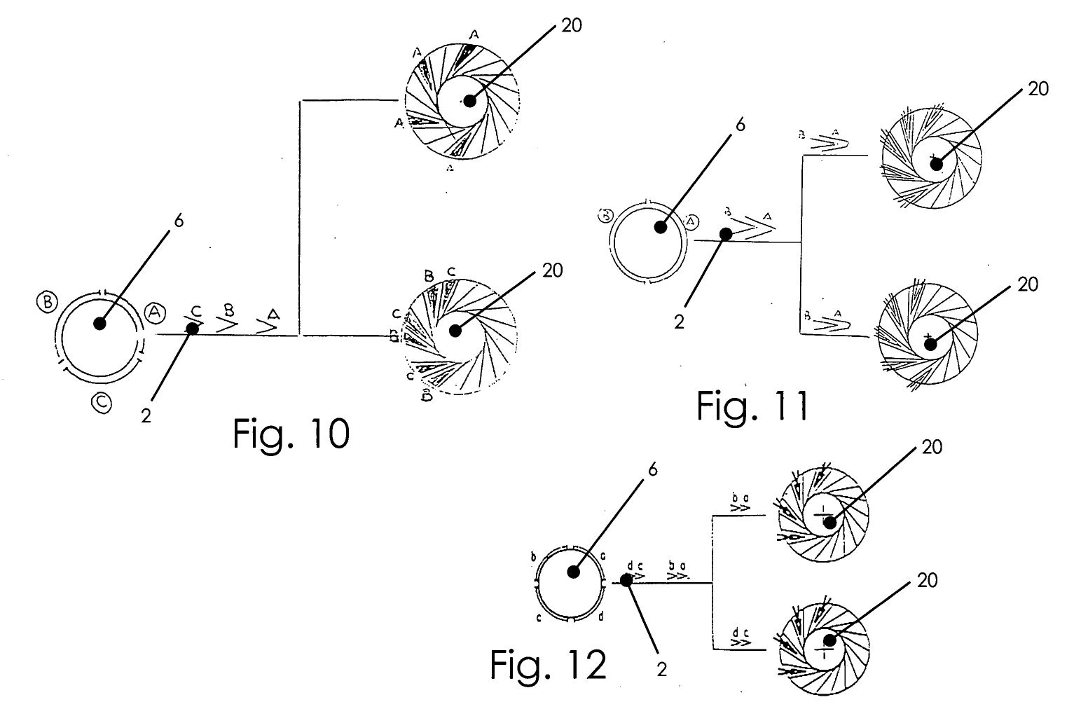

FIG. 9 shows an output in which the second type of cam is used. As can be seen, fascicles 2 of types A, B and C are routed separately toward three different collecting devices 20. FIG. 10 shows another output in which the second type of cam is used. As can be seen, fascicles 2 of three types A, B and C are routed such that the fascicles 2 of type A go to a collecting device 20, while fascicles 2 of types B and C go to a different collecting device 20.

FIG. 11 shows an output in which the third type of cam is used. As can be seen, fascicles 2 of types A and B are inserted one inside the other in the combination A and B on two collecting devices 20. FIG. 12 shows another output in which the third type of cam is used. As can be seen, fascicles 2 of types a, b, c and d are routed such that a and b are inserted one inside the other on a collecting device, while types c and d are inserted one inside the other on another collecting device.

As will be appreciated by one of ordinary skill in the art with reference to this disclosure, many output combinations other than those depicted in FIGS. 5-12 are possible, such as by using different cams or different combinations of cams.

Generally, in order to obtain the different output combinations of fascicles using three cams, an operator must manually move the small roller through a horizontal translation next to the cam to be lowered by unscrewing a holding lever, moving the small roller and then, screwing the holding lever in place again. This operation requires the operator to access internal parts of the machine which can be dangerous, as well as requiring that production stop while moving the small roller. Further, moving the small roller improperly can result in output errors.

Therefore, there is a need for a new sheering device that is not associated with these disadvantages.

### SUMMARY

According to one embodiment of the present invention, there is provided a sheering device for routing folded fascicles advancing on a path through a printing line onto one or more than one collecting device. The sheering device comprises a comb-shaped sheerer adapted to assume a raised position and a lowered position with respect to the advancement path of fascicles, two or more than two cams connected to the comb-shaped sheerer which raise and lower the comb-shaped sheerer, and one or more than one motor. The one or more than one motor is adapted to automatically select one of the two or more than two cams and drive the selected cam according to the upstream advancement speed of a folding machine which folds the printed material into fascicles. In one embodiment, the one or more than one motor has an alternate current and digital vector control. In another embodiment, the motor is controlled by a computer connected to an encoder that provides information related to the position of the fascicles within the printing line.

In a preferred embodiment, at least one of the two or more than two cams is adapted to realize at least two operating ratios. In one embodiment, the two or more than two cams is two cams. In another embodiment, the two or more than two cams is at least three cams.

In one embodiment, the sheering device further comprises a device for pneumatically driving a small roller that actuates the comb-shaped sheerer. In another embodiment, the sheering device further comprises a device for pneumatically driving the two or more than two cams in cooperation with the device for pneumatically driving a small roller.

According to another embodiment of the present invention, there is provided a method of routing folded fascicles onto one or more than one collecting device. The method comprises, first, providing a sheering device according to the present invention. Then, the fascicles are contacted with the sheering device, thereby routing each fascicle to one or at least two collecting devices.

According to another embodiment of the present invention, there is provided a printing line for folding and collecting fascicles. The printing line comprises a sheering device according to the present invention, a folding machine connected in series upstream from the sheering device, and two or more than two collecting devices for collecting fascicles connected in series downstream from the sheering device.

According to another embodiment of the present invention, there is provided a method of producing printed matter. The method comprises, first, providing a printing line according to the present invention, folding printed matter in the folding machine, and routing the folded matter through the one or more than one sheering device and onto two or more than two collecting devices.

These and other features, aspects and advantages of the present invention will become better understood with regard to the following description, appended claims, and accompanying figures where:

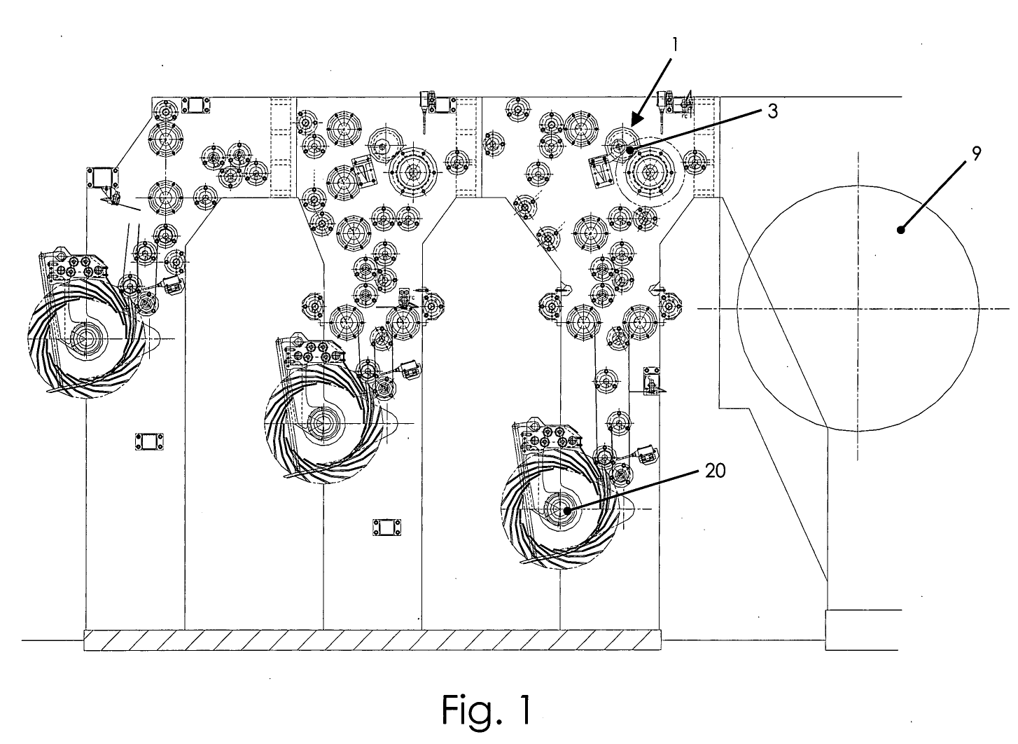

FIG. 1 is a schematic, lateral perspective view of a part of a printing line according to the present invention;

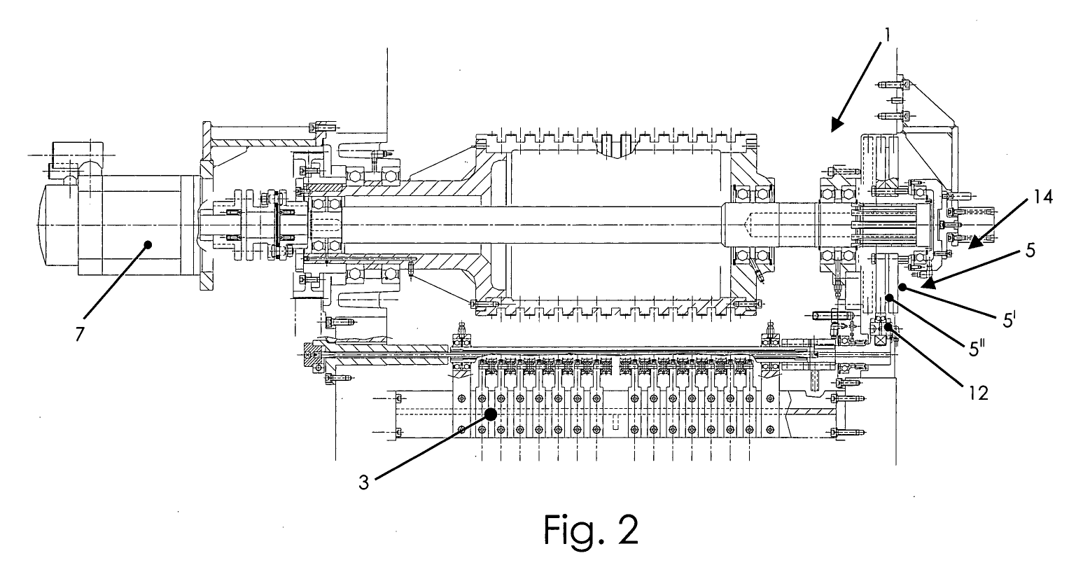

FIG. 2 is a cutaway, lateral perspective view of a sheering device according to the present invention;

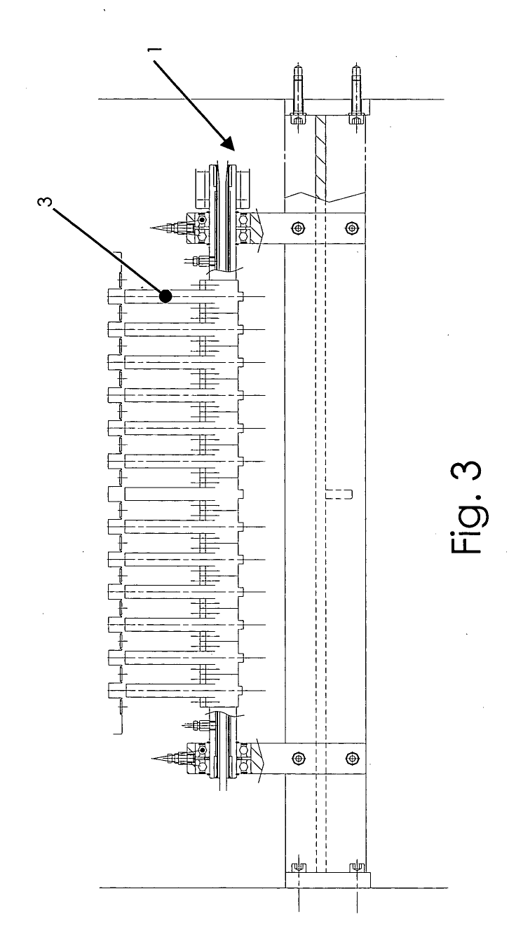

FIG. 3 is a front perspective view of the sheering device shown in FIG. 2;

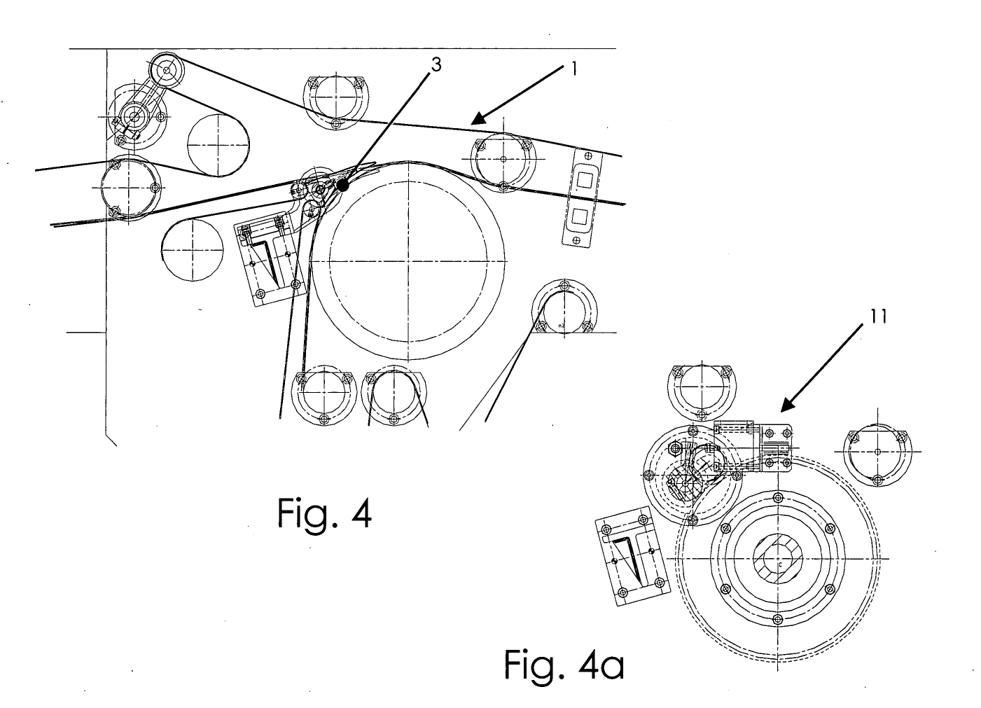

FIG. 4 is a detailed, lateral perspective view of a sheering device according to the present invention;

FIG. 4a is detailed, lateral perspective view of a driving means according to the present invention; and

FIG. 5 through FIG. 12 are schematic depictions of various output combinations of different types of fascicles being routed from a cylinder toward collecting devices.

### DESCRIPTION

According to one embodiment of the present invention, there is provided a sheering device for routing folded fascicles onto one or more than one collecting device. According to another embodiment of the present invention, there is provided a method of routing folded fascicles onto one or more than one collecting device. In one embodiment, the method comprises providing a sheering device according to the present invention. According to another embodiment of the present invention, there is provided a printing line for folding and collecting fascicles. In one embodiment, the printing line comprises a sheering device according to the present invention. According to another embodiment of the present invention, there is provided a method of producing printed matter. In one embodiment, the method comprises providing a printing line of the present invention. The devices and methods of the present invention will now be disclosed in greater detail.

As used herein, the term “comprise” and variations of the term, such as “comprising” and “comprises,” are not intended to exclude other additives, components, integers or steps.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

According to one embodiment of the present invention, there is provided a sheering device for routing folded fascicles onto one or more than one collecting device. Referring now to FIG. 1 through FIG. 12, there are shown, respectively, a schematic, lateral perspective view of a printing line according to the present invention (FIG. 1); a cutaway, lateral perspective view of a sheering device according to the present invention (FIG. 2); a front perspective view of the sheering device of FIG. 2 (FIG. 3); a detailed, lateral perspective view of a sheering device according to the present invention (FIG. 4); a detailed, lateral perspective view of a driving means according to the present invention (FIG. 4a); and schematic depictions of various output combinations of different types of fascicles being routed from a cylinder toward collecting devices (FIG. 5 through FIG. 12).

The sheering device 1 of the present invention, routes fascicles 2 toward two different downstream paths. As can be seen, the sheering device 1 comprises a comb-shaped sheerer 3 adapted to assume a raised position and a lowered position with respect to the advancement path of fascicles 2. The sheering device 1 further comprises two or more than two cams 5 (shown as two cams 5′ and 5″ in FIG. 2) connected to the comb-shaped sheerer which raise and lower the comb-shaped sheerer 3. Preferably, at least one of the two or more than two cams is adapted to realize at least two operating ratios, thereby decreasing the number of cams needed as compared to a conventional sheering device where each cam is adapted to realize only one operating ratio.

The sheering device 1 further comprises one or more than one motor 7. Preferably, the motor 7 has alternate current and digital vector control that is adapted to automatically select one of the two or more than two cams and drive the selected cam according to the upstream advancement speed of a folding machine 9 which folds the printed material into fascicles. The motor 7 is preferably controlled by a computer connected to an encoder, as will be appreciated by one of ordinary skill in the art with reference to this disclosure, that provides information related to the position of the fascicles 2 within the printing line. The at least one motor 7 operates the sheering device 1 in precise synchrony with the folding machine 9 and collecting devices 20, and with the other components of the printing line in order to route the fascicles appropriately. By using at least one cam adapted to realize at least two operating ratios, and a motor to drive the cams, fewer cams can be used to control the fascicle combination output onto the collecting devices than with a conventional sheering device and the cams are adjusted without the need for an operator to stop the production line and manually adjust the cams.

For example, in the embodiment shown in the FIG. 1 through FIG. 4a, only two cams 5′, 5″ are used for routing fascicles needing three operating ratios, which in conventional sheering devices would require three separate cams, because one cam 5′ is adapted to realize two operating ratios while the second cam 5″ is adapted to realize one operating ratio. The first cam 5′ turns at a pitch of 180° with two different speeds, one speed being twice the other speed, in order to perform a driving stroke every 180° of each of its turns or a driving stroke every 90° of each of its turns depending on the application and according to the selected speed. The second cam 5″ turns at a pitch of 120° in order to perform a driving stroke every 120° of each of its turns.

Preferably, the sheering device 1 further comprises a device 11 for pneumatically driving the small roller 12 that actuates the comb-shaped sheerer 3 in order to raise and lower the small roller 12 causing the small roller 12 to move away from and to move toward the cams 5, respectively. The sheering device 1 further comprises a device 14 for pneumatically driving the two or more than two cams 5, and that cooperates with the device 11, in order to move, through a horizontal translation, the cam to be activated to the lifted small roller 12. By using the devices 11 and 14, exchanging cams on the operating small roller 12 is completely automatic because the pneumatic devices 11 and 14 are operated remotely, since the two operating positions involving cam 5 and small roller 12 can be attained with a pneumatic drive of the piston type that operates between its two common positions located at the end of its strokes, such positions corresponding to the positions in which the small roller 12 will get in contact with one of the two cams 5 to be activated.

According to another embodiment of the present invention, there is provided a method of routing folded fascicles onto one or more than one collecting device. In one embodiment, the method comprises providing a sheering device according to the present invention. The method further comprises contacting the fascicles with the sheering device, thereby routing each fascicle to one or at least two collecting devices.

According to another embodiment of the present invention, there is provided a printing line for folding and collecting fascicles. In one embodiment, the printing line comprises a sheering device according to the present invention. In a preferred embodiment, the printing line further comprises a folding machine connected in series upstream from the sheering device, and two or more than two collecting devices for collecting fascicles connected in series downstream from the sheering device. For example, referring now to FIG. 1, there is shown a printing line for folding and collecting fascicles according to the present invention, comprising at least one folding machine 9 which folds the printed material into fascicles, at least one sheering device 1 (two as shown) connected in series downstream of the folding machine 9, and at least two collecting devices 20 (three as shown) of the fascicles connected downstream of the sheering device 1.

According to another embodiment of the present invention, there is provided a method of producing printed matter. In one embodiment, the method comprises providing a printing line of the present invention. The method further comprises folding printed matter in the folding machine, routing the folded matter through the one or more than one sheering device according to the present invention and onto two or more than two collecting devices.

As will be appreciated by one of ordinary skill in the art with reference to this disclosure, although the sheering device of the present invention is disclosed with respect to routing folded fascicles of printed paper material, such as newspapers, on rotary printing lines, the sheering device of the present invention can be used in many other types of machines where it is necessary to route objects that move in a row along a pre-established path.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference to their entirety.

What is claimed is:

1. A sheering device for routing folded fascicles advancing on a path through a printing line onto one or more than one collecting device comprising:
a) a comb-shaped sheerer adapted to assume a raised position and a lowered position with respect to the advancement path of fascicles;
b) two or more than two cams connected to the comb-shaped sheerer which raise and lower the comb-shaped sheerer; and
c) one or more than one motor;
where the one or more than one motor is adapted to automatically select one of the two or more than two cams and drive the selected cam according to the upstream advancement speed of a folding machine which folds the printed material into fascicles.

2. The sheering device of claim 1, where the one or more than one motor has an alternate current and digital vector control.

3. The sheering device of claim 1, where the motor is controlled by a computer connected to an encoder that provides information related to the position of the fascicles within the printing line.

4. The sheering device of claim 1, where at least one of the two or more than two cams is adapted to realize at least two operating ratios.

5. The sheering device of claim 4, where the two or more than two cams is two cams.

6. The sheering device of claim 4, where the two or more than two cams is at least three cams.

7. The sheering device of claim 1, further comprising a device for pneumatically driving a small roller that actuates the comb-shaped sheerer.

8. The sheering device of claim 7, further comprising a device for pneumatically driving the two or more than two cams in cooperation with the device for pneumatically driving a small roller.

9. A method of routing folded fascicles onto one or more than one collecting device comprising:
a) providing a sheering device according to claim 1; and
b) contacting the fascicles with the sheering device, thereby routing each fascicle to one or at least two collecting devices.

10. A method of routing folded fascicles onto one or more than one collecting device comprising:
a) providing a sheering device according to claim 4; and
b) contacting the fascicles with the sheering device, thereby routing each fascicle to one or at least two collecting devices.

11. A printing line for folding and collecting fascicles comprising:
a) a sheering device according to claim 1;
b) a folding machine connected in series upstream from the sheering device; and
c) two or more than two collecting devices for collecting fascicles connected in series downstream from the sheering device.

12. A printing line for folding and collecting fascicles comprising:
a) a sheering device according to claim 4;
b) a folding machine connected in series upstream from the sheering device; and
c) two or more than two collecting devices for collecting fascicles connected in series downstream from the sheering device.

13. A method of producing printed matter comprising:
a) providing a printing line according to claim 11;
b) folding printed matter in the folding machine; and
c) routing the folded matter through the one or more than one sheering device and onto two or more than two collecting devices.

14. A method of producing printed matter comprising:
a) providing a printing line according to claim 12; and
b) folding printed matter in the folding machine;
c) routing the folded matter through the one or more than one sheering device and onto two or more than two collecting devices.
